(19) United States
(12) Patent Application Publication
(10) Pub. No.: US 2018/0035711 A1
(43) Pub. Date: Feb. 8, 2018

(54) AUTOMATIC CIGARETTE MAKING SYSTEM

(71) Applicant: KENDYL ALEXANDER RAYSON, POMONA, CA (US)

(72) Inventor: KENDYL ALEXANDER RAYSON, POMONA, CA (US)

(21) Appl. No.: 15/230,495

(22) Filed: Aug. 8, 2016

(51) Int. Cl. A24F 15/10; A24C 5/39; B02C 18/22; A24F 15/04; A24F 25/00; A24C 5/00; A24B 7/04

(52) U.S. Cl. CPC A24F 15/10; A24C 5/002; A24C 5/393; A24B 7/04; A24F 15/04; A24F 25/00; B02C 18/2216; B02C 2018/164

(57) ABSTRACT

The present invention relates to an automatic cigarette making system which is enabled to provide the various function of production of the cannabis cigarette by a single system which is further enabled to reduce the cost and the time of the production of the cannabis cigarette.

### FIELD OF THE INVENTION

The present invention relates to an automatic cigarette making system enable to provide the various function of production of the cannabis cigarette by a single system which further helps reducing the cost and the time of the production of the cannabis cigarette.

### BACKGROUND OF THE INVENTION

Many cigarette smokers prefer making their own cigarettes rather than buying them pre-made. One reason for this is that the cigarette components, that is loose cigarette tobacco and cigarette wraps, are often less expensive than an equivalent number of complete cigarettes. Also, many people find a certain satisfaction in making articles for their own use instead of relying entirely on a commercial manufacturer. The simplest approach to rolling one's own cigarettes, of course, is to make them from scratch from loose tobacco and cigarette wrappers without any mechanical aids. There are certain disadvantages to this approach, however; it is relatively difficult to obtain a cigarette of uniform density, and inconvenient to make a cigarette in this fashion outdoors in inclement weather. For those who smoke cannabis the process for converting the plant material into a smoke able form consists of several steps. Generally the product is obtained by the user in a dry bud form. The quantity is then measured by weight. The dry bud is broken down into smaller pieces by hand or by use of a grinding implement. The smaller pieces rendered are better suited for combustion. The grinded cannabis is then rolled into a cigarette form or placed into a pipe for smoking. These steps are time consuming and without practice can also yield inconsistent results. The process of rolling a cigarette requires some skill and can result in lost cannabis or rolling paper if not executed properly.

Moreover, the various system now available is not suitable, as they fail to sum up the various steps involves in the production of the cannabis cigarette into one single system, wherein to buy different systems to perform different steps been involved in the production of the cannabis cigarette is highly costly, time consuming and further involves lot of labour work which makes them in convenient for use.

Therefore, there remains a need to overcome above mentioned problems and our invention resolve this entire problem.

### SUMMARY OF THE INVENTION

The main objective of the present invention is to overcome the limitations of the prior art(s) by providing an automatic cigarette making system enable to provide the various function of production of the cannabis cigarette by a single system which further helps reducing the cost and the time of the production of the cannabis cigarette.

An automatic cigarette making system comprises: a body portion, having a first end to receive a filler material; grinder having plurality of blades coupled to the body portion at a first level, wherein at least one of the plurality of blades are enabled for grinding the received filler material; at least one vibrator coupled to the body portion at a second level, wherein the at least one vibrator is enabled to remove clogs from the grinded filler material; a measurement unit coupled to the body portion at a third level, wherein the measurement unit is enabled to measure the quantity of the filler material to be dispensed from the vibrator after the removal of the clogs from the grinded filler material; at least one open section at the second end of the body portion, wherein the open section is enabled to dispense the measured amount of unclogged grinded filler material onto a paper feed, wherein the paper feed is held by two horizontal arms of a rolling unit hinged across the width of the body portion, wherein the two arms are enabled to rotate in two opposite direction to output a roll of the paper feed containing the measured amount of unclogged grinded filler material.

Moreover, the automatic cigarette making system is enabled to provide a convenient and compatible way of producing cigarette from the automatic cigarette making system. It sum up the various process of cigarette making into a single system thereby enable the at least one user a consistence way to produce the cigarette and of equal diameter.

### BRIEF DESCRIPTION OF THE DRAWINGS

The following drawings illustrates exemplary embodiment; however, they are helpful in illustrating objects, features and advantages of the present invention because the present invention will be more apparent from the following detailed description taken in conjunction with accompanying drawings in which:

FIG. 1 illustrates the cross sectional of the given invention according to an embodiment of the invention.

FIG. 2 illustrates the flow chart of the given invention according to an embodiment of the invention.

### DETAIL DESCRIPTION OF THE INVENTION

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

References to “one embodiment,” “at least one embodiment(s),” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described. All publications, patents and patent computer implemented methods mentioned herein are incorporated herein in their entirety.

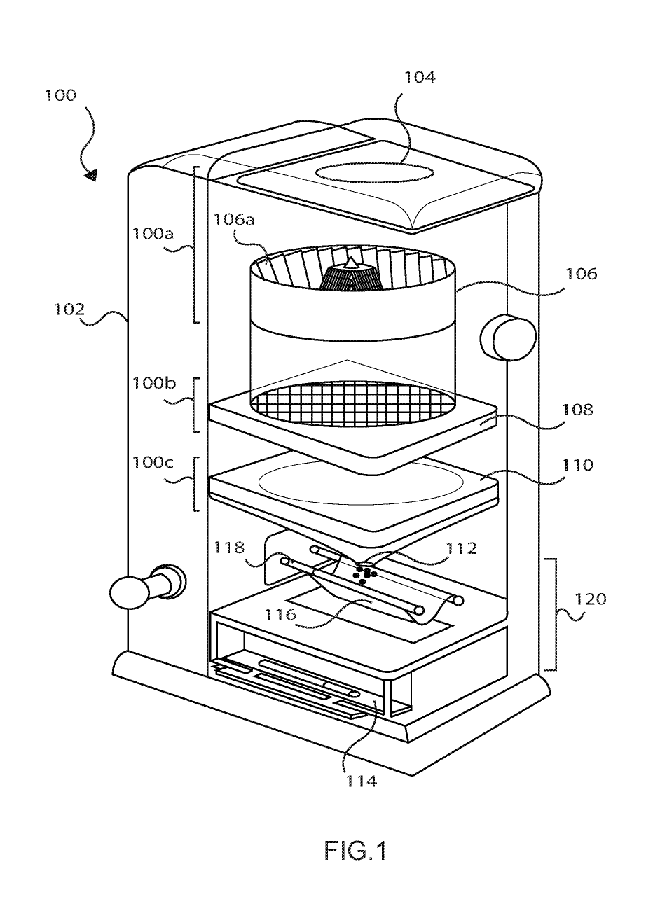

FIG. 1 illustrates an automatic cigarette making system [100] enable to provide the various function of production of the cigarette by a single system which further helps reducing the cost and the time of the production of the cigarette. An automatic cigarette making system [100] comprises a body portion [102], having a first end [104] to receive a filler material; grinder [106] coupled to plurality of blades [106a] coupled to the body portion [102] at a first level [100a], at least one vibrator [108] coupled to the body portion [102] at a second level [100b], a measurement unit [110] coupled to the body portion [102] at a third level [100c] at least one open section [112] at the second end [114] of the body portion [102], wherein the at least one open section [112] is enabled to dispense the measured amount of unclogged grinded filler material onto a paper feed [116], wherein the paper feed [116] is held by two horizontal arms [118] of a rolling unit [120] hinged across the width of the body portion [102], wherein the two arms [118] are enabled to rotate in two opposite direction to output a roll of the paper feed [116] containing the measured amount of unclogged grinded filler material.

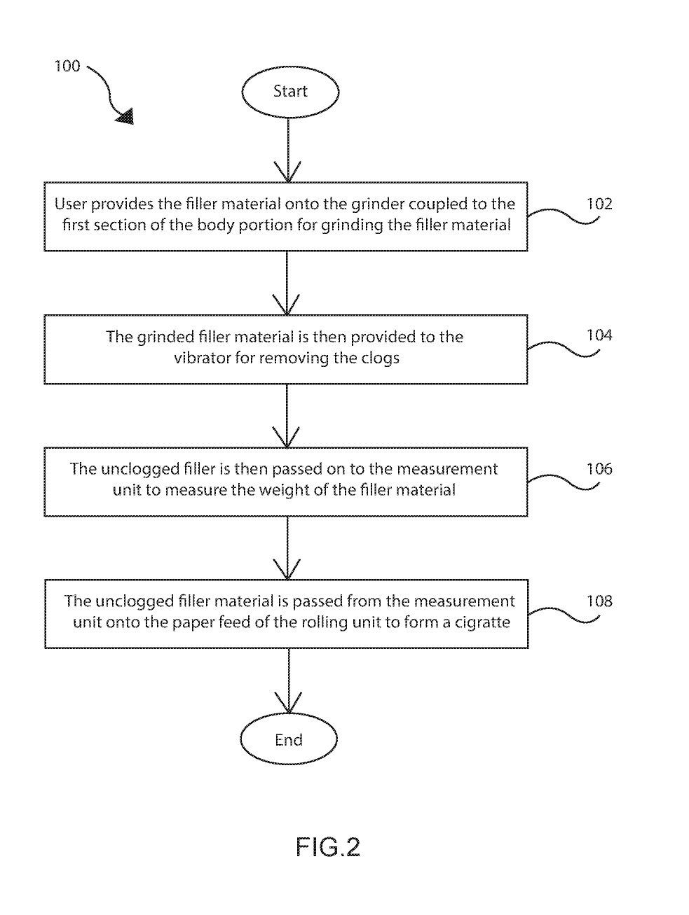

FIG. 2 illustrates the flow chart of the given invention according to an embodiment of the invention which is also the preferred embodiment of the invention.

Step. 102 of FIG. 2 illustrates the process of providing a filler material via at least one user to the first section of the body portion, wherein the filler material comprises any one of cannabis, tobacco, marijuana, weed or the combination thereof. These filler material been provided to the body portion is in solid, seed or plant form, wherein in order to make it compatible for smoking or usage purpose the filler material is required to be in the grinded form therefore, the filler material is further send to the grinder coupled to plurality of blades. The plurality of blade is coupled to the body portion at a first level, wherein at least one of the pluralities of blade is enabled for grinding the received filler material. The plurality of the blade used herein, is made up of carbon, steel, cobalt, stainless steel, ceramic, obsidian, plastic or the combination thereof. The first section mentioned above is small hollow opening to the body portion, wherein the first section is further provided with a plastic as well as a transparent lid. In order to provide the body portion with the filler material the at least one user is first enabled to remove or slide the transparent lid above the body portion and provide the body portion with the filler material for the further process. The body portion herein is further coupled to a display unit, wherein this display unit comprises a display screen and buttons. The buttons provided to the display screen is enabled to fix the various tasks to be performed by the system and is further enabled to display the outcome or the status of accomplishment of the task via system on the display screen. The various buttons provided to the display unit is means for switching the system ON/OFF, set coarseness of grind, set weight/quantity to be grinded and to be dispensed, set cigarette size to be rolled, set quantity of cigarettes to be produced, Up/Down keys to toggle on screen options, On/Off for backlighting, start process, deposit filler material from scale into grinder or the combination thereof.

Step. 104 of FIG. 2 illustrates the process of providing the filler material to the at least one vibrator coupled at the second level of the body portion. This process of enabling the filler material to the at least one vibrator enables to remove the clogs from the grinded filler material and further makes it compatible for the usage. The at least one vibrator is coupled inside a funnel wherein the funnel is further housed inside the body portion. Once the grinding process of the filler material is been accomplished the filler material is let inside the funnel, wherein the at least one vibrator when in the vibrating state enables the filler material to vibrate this in turn is enable removing any clogs in the filler material thereby providing a fine grinded form of the filler material. The funnel coupled with a vibrator provides the gravity aids to the filler material in order to aid the movement of the unclogged grinded filler material in the right direction.

Step. 106 of FIG. 2 illustrates the process of measurement of the received unclogged grinded filler material through the at least one vibrator coupled inside the funnel, wherein the filler material is received on to the measurement unit coupled at the third level of the body portion wherein, the measurement unit is provided with a meter to measure the weight of the filler material according to the requirement of the at least one user.

Step. 108 of FIG. 2 illustrate the rolling process of the paper feed provided to the rolling unit. At least one open section at the second end of the body portion, wherein the open section is enabled to dispense the measured amount of unclogged grinded filler material onto a paper feed, wherein the paper feed is held by two horizontal arms of a rolling unit hinged across the width of the body portion, wherein the two arms are enabled to rotate in two opposite direction to output a roll of the paper feed containing the measured amount of unclogged grinded filler material. The two horizontal arms move laterally underneath the open section to collect the grinded filler material. The rolling arms come together compressing the filler material and begin to rotate to roll it. Paper is supplied by the automatic paper feed, and a ‘crutch’ or filter which is installed automatically as well. Once the cigarette is been rolled, the two horizontal arms moves down and back allowing the rolled cigarette to drop onto a ramp. Paper is dispensed through a slot to the rolling unit automatically, signaled by an electronic process. The paper feed consists of a spool of rolling paper which is rotated to dispense paper; the paper feed contain a cutting mechanism as well. Paper used herein, as the paper feed is enabled to be replaced in rolls; it is segmented and contains an adhesive that is present on the roll of paper feed and activated upon dispensation or applied to the paper feed upon dispensation. Once rolled, the cigarette is dropped from the rolling unit; it falls onto a ramp which leads into a humidor chamber. This ramp raise to close the humidor chamber when not in use. The humidor chamber gives the at least one user a place to receive the cigarette and keep the cigarette in a controlled humidity during storage. Cigarettes are retrieved from the humidor chamber by pushing down on a dispenser tab. The dispenser tab when depressed tilts the floor of the humidor chamber and provides an opening on the front of the chamber for the cigarette to roll out of, and onto the dispenser tab. This rolling unit further comprises a lighter as well enable to lighten up the cigarette dispensed form the dispenser for the at least one user.

In other embodiment of the given invention illustrates that the plurality of blades and the at least one vibrator is either removably coupled or is integrally coupled to the body portion.

What is claimed is:

1. An automatic cigarette making system comprises: a body portion, having a first end to receive a filler material; plurality of blades coupled to the body portion at a first level, wherein at least one of the plurality of blades are enabled for grinding the received filler material; at least one vibrator coupled to the body portion at a second level, wherein the at least one vibrator is enabled to remove clogs from the grinded filler material; a measurement unit coupled to the body portion at a third level, wherein the measurement unit is enabled to measure the quantity of the filler material to be dispensed from the vibrator after the removal of the clogs from the grinded filler material; at least one open section at the second end of the body portion, wherein the open section is enabled to dispense the measured amount of unclogged grinded filler material onto a paper feed, wherein the paper feed is held by two horizontal arms of a rolling unit hinged across the width of the body portion, wherein the two arms are enabled to rotate in two opposite direction to output a roll of the paper feed containing the measured amount of unclogged grinded filler material.

2. The system in claim 1; wherein the at least one vibrator and the plurality of blade are integrally coupled to the system.

3. The system in claim 1; wherein the at least one vibrator and the plurality of blade are removably coupled to the system.

4. The system in claim 1; wherein the system is also provided with a lighting unit enable lighten up the roll of the at least one paper feed on the at least one user choice.

5. The system in claim 1; wherein the system is provided with a collection chamber to provide at least one user a place to receive the cigarette and also keep the cigarette in a controlled humidity during storage, wherein the cigarettes from the collection is retrieved by pushing down on a dispenser tab.

6. The system in claim 1; wherein the at least one paper feed provided to the rolling unit contains an adhesive which is enabled to stick the at least one paper feed to form a roll.
